(19) United States
(12) Patent Application Publication
(10) Pub. No.: US 2014/0294524 A1
(43) Pub. Date: Oct. 2, 2014

(54) PENTAGON-SHAPED CUTTING INSERT AND SLOTTING CUTTER THEREFOR

(71) Applicant: Kennametal Shared Services Private Limited, Bangalore (IN)

(72) Inventors: Prem Kumar, Bangalore (IN); Sivapapachari Chennuri, Bangalore (IN)

(21) Appl. No.: 14/205,460

(22) Filed: Mar. 12, 2014

(30) Foreign Application Priority Data
Mar. 27, 2013 (IN) 1356/CHE/2013

(51) Int. Cl. B23C 5/20; B23C 5/08

(52) U.S. Cl. CPC B23C 5/207; B23C 5/08; B23C 2200/0444; B23C 2200/08; B23C 2210/244
USPC 407/51; 407/113; 407/114

(57) ABSTRACT

A cutting insert for machining a workpiece includes a top surface; a bottom surface. A plurality of peripheral side surfaces extend between the top and bottom surfaces. Each side surface includes an arcuate-shaped surface and a substantially planar surface. Each substantially planar surface is formed with a true angle with respect to a plane perpendicular to the top and bottom surfaces that results in a relatively smaller resultant angle when mounted in a slotting cutter to produce a true 90 degree wall on a workpiece during a slotting cutting operation.

### BACKGROUND OF THE INVENTION

The invention relates in general to a cutting insert that may be detachably mounted on a tool holder for cutting a workpiece, and in particular to a pentagon-shaped cutting insert that is capable of machining a true ninety degree wall in a workpiece when mounted in a slotting cutter.

Slotting cutters are known for cutting keyways and the like and, also, for providing work members with slots of various width. Slotting cutters are somewhat similar to milling cutters in that the cutter usually employs a disc-like member having cutting inserts mounted in the periphery thereof. In a milling cutter, the cutting inserts are generally presented axially, whereas, in a slotting cutter, the cutting inserts protrude radially from the supporting disc and are, thus, presented to the workpiece in the radial direction. Because the cutting inserts are presented to the workpiece in the radial direction, one problem associated with use of a cutting insert in a slotting cutter is the difficulty in machining a true 90 degree wall in the workpiece.

### SUMMARY OF THE INVENTION

The problem of machining a true 90 degree wall in a workpiece with a cutting insert mounted on a slotting cutter is solved by providing each peripheral side surface formed with a true angle with respect to a plane perpendicular to the top and bottom surfaces of the cutting insert, wherein the true angle provides a relatively smaller resultant angle when mounted on the slotting cutter.

In one aspect of the invention, a cutting insert for machining a workpiece comprises a top surface; a bottom surface; a plurality of peripheral side surfaces extending between the top and bottom surfaces, each side surface including an arcuate-shaped surface and a substantially planar surface, each arcuate-shaped surface being formed with a radius of curvature, R, and a depth, D; and a plurality of cutting edges formed at an intersection between the top and bottom surfaces, the arcuate-shaped surface and the planar surface of an immediately adjacent peripheral side surface, wherein each peripheral side surface is formed with a true angle with respect to a plane perpendicular to the top and bottom surfaces that results in a relatively smaller resultant angle when mounted in the slotting cutter to produce a true 90 degree wall on a workpiece during a slotting cutting operation.

In another aspect of the invention, a slotting cutter has a plurality of insert receiving pockets, each pocket has a cutting insert mounted thereon, the cutting insert comprises a top surface; a bottom surface; a plurality of peripheral side surfaces extending between the top and bottom surfaces, each side surface including an arcuate-shaped surface and a substantially planar surface, each arcuate-shaped surface being formed with a radius of curvature, R, and a depth, D; and a plurality of cutting edge formed at an intersection between the top and bottom surfaces, the arcuate-shaped surface and the planar surface of an immediately adjacent peripheral side surface, wherein each peripheral side surface is formed with a true angle with respect to a plane perpendicular to the top and bottom surfaces that results in a relatively smaller resultant angle when mounted in the slotting cutter to produce a true 90 degree wall on a workpiece during a slotting cutting operation.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 shows a perspective view of a pentagon-shaped cutting insert according to an embodiment of the invention;

FIG. 2 shows a top view of the cutting insert of FIG. 1;

FIG. 3 shows a a cross-sectional view of the cutting insert taken along line 3-3 of FIG. 2;

FIG. 4 shows an end view of the cutting insert of FIG. 1;

FIG. 5 shows a cross-sectional view of the cutting insert taken along line 5-5 of FIG. 4;

FIG. 6 shows a perspective view of a slotting cutter with the cutting insert of FIG. 1 mounted thereon according to an embodiment of the invention;

FIG. 7 shows a side view of the slotting cutter of FIG. 6;

FIG. 8 shows an end view of the slotting cutter of FIG. 6; and

FIG. 9 shows an enlarged view of the cutting insert mounted on the pocket of the slotting cutter of FIG. 6.

### DETAILED DESCRIPTION OF THE INVENTION

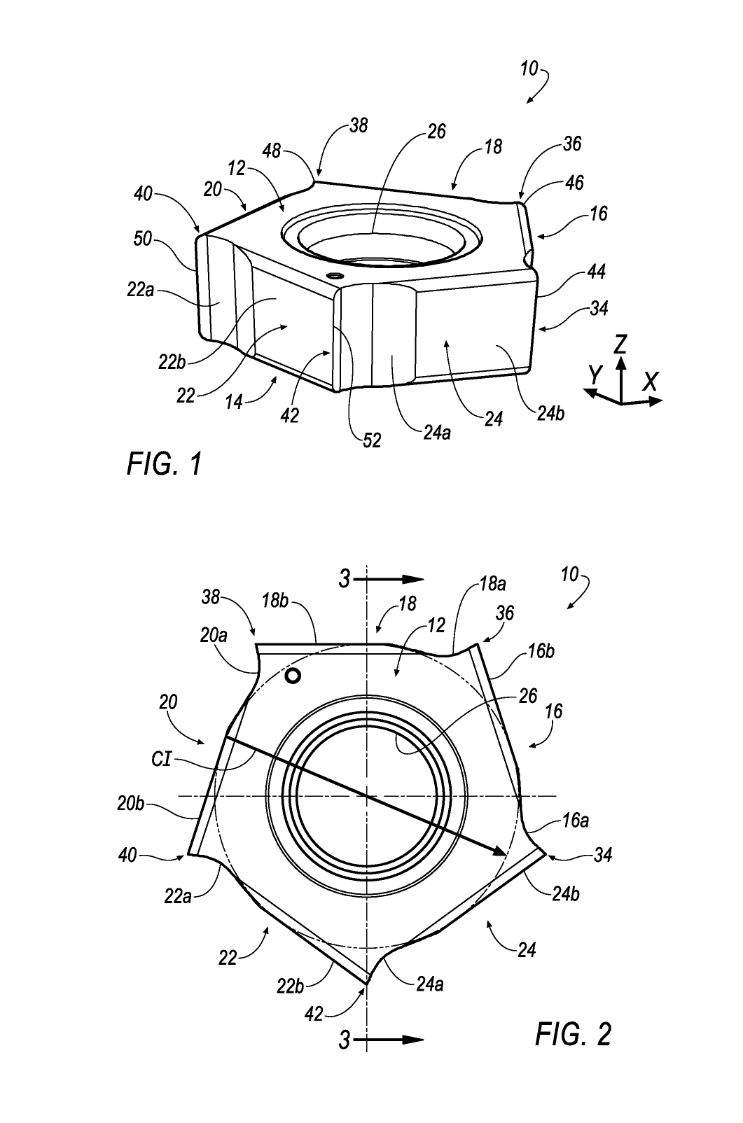

Referring now to FIGS. 1-5, a cutting insert 10 is shown according to an embodiment of the invention. In general, the cutting insert 10 is generally pentagon in shape having symmetry about the z-axis. Thus, the cutting insert 10 can be indexed by rotating the cutting insert 10 about the z-axis to present a different cutting edge to the workpiece (not shown). It will be appreciated that a generally pentagon-shaped cutting insert is illustrated, the principles of the invention described below can be applied to a cutting insert having any polygonal shape, such as a trigon, a diamond, a square, a hexagon, and the like.

The cutting insert 10 has substantially parallel top and bottom surfaces 12, 14, respectively, and peripheral side surfaces 16, 18, 20, 22 and 24 extending between the top and bottom surfaces 12, 14. The cutting insert 10 also includes a countersunk bore 26 extending between the top and bottom surfaces 12, 14 for accommodating a mounting screw (not shown) for mounting the cutting insert 10 to a cutting tool.

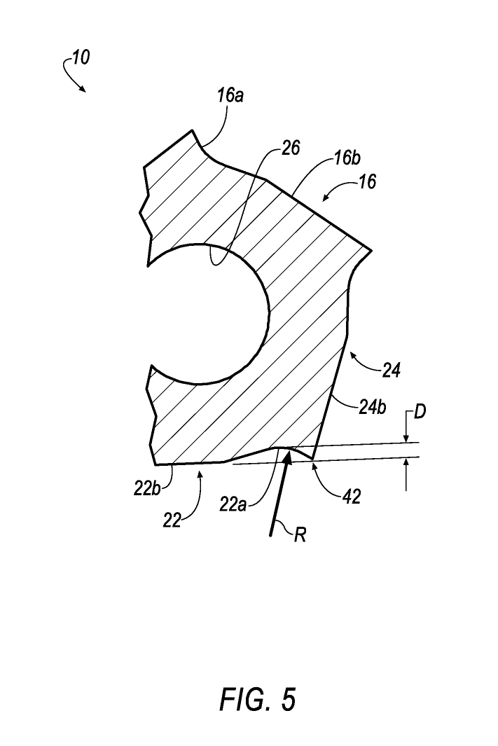

Each side surface 16, 18, 20, 22 and 24 includes an arcuate-shaped surface 16a, 18a, 20a, 22a, 24a and a substantially planar surface 16b, 18b, 20b, 22b, 24b. The substantially planar surface 16b, 18b, 20b, 22b, 24b extends a greater distance along the peripheral side surface 16, 18, 20, 22, 24 than the arcuate-shaped surface 16a, 18a, 20a, 22a, 24a. The arcuate-shaped surface 16a, 18a, 20a, 22a, 24a is formed with a radius of curvature, R, and a depth, D. In one embodiment, the radius of curvature is about between about 0.04 inch (1.0 mm) to about 0.08 inch (2.0 mm), and the depth, D, is between about 0.001 inch (0.25 mm) to about 0.003 inch (0.75 mm). For example, the radius of curvature, R, can be about 0.06 inch (1.5 mm) and the depth, D, can be about 0.002 inch (0.5 mm), as shown in FIG. 5. In one embodiment, the substantially planar surfaces 16b, 18b, 20b, 22b, 24a contact an inscribed circle, IC, of the cutting insert 10, as shown in FIG. 2.

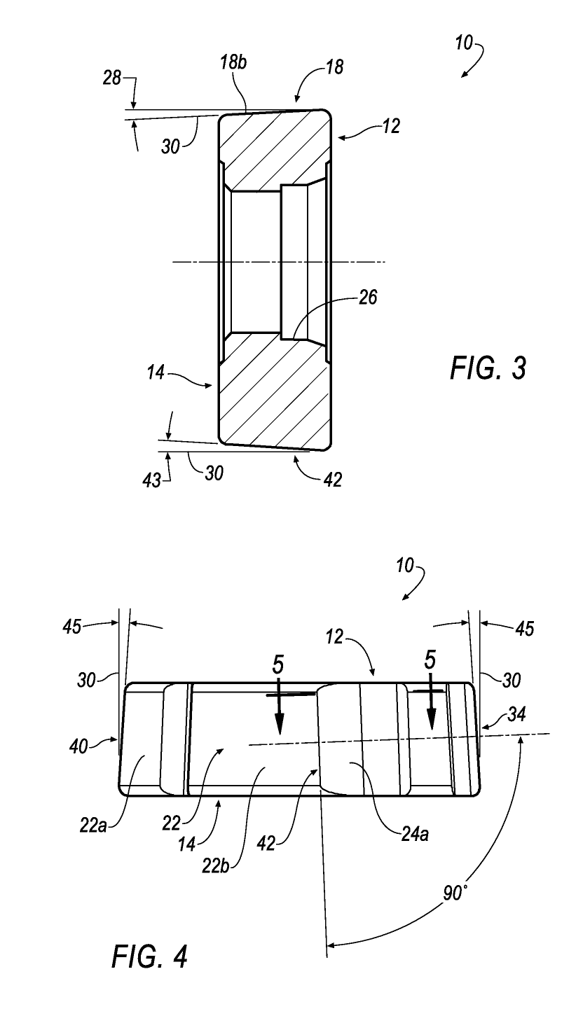

One aspect of the invention in that each substantially planar surface 16b, 18b, 20b, 22b, 24b of each side surface 16, 18, 20, 22 and 24 is formed at a true angle 28 with respect to a plane 30 perpendicular to the top and bottom surfaces 12, 14, as shown in FIG. 3. In one embodiment, the true angle 28 can be between about zero (0) degrees and about five (5) degrees. For example, the true angle 28 can be about three (3) degrees. When the cutting insert 10 is mounted on the pocket of the slotting cutter 100, the true angle 28 results in a relatively smaller resultant angle 32 that produces a true ninety (90) degree wall on the workpiece (not shown) during a slotting cutting operation, as shown in FIG. 9. For example, in one embodiment, the resultant angle 32 is about 2.14 degrees for a true angle 28 of about 3.00 degrees.

The cutting insert 10 also has five cutting corners 34, 36, 38, 40 and 42 formed at the intersection between each of the side surfaces 16, 18, 20, 22, 24 and the top surface 12. The number of cutting corners 34, 36, 38, 40 and 42 correspond to the number of peripheral side surfaces 16, 18, 20, 22 and 24 of the cutting insert 10. It will be appreciated that the principles of the invention can be practiced with a cutting insert having a different number of peripheral side surfaces, and hence a different number of cutting corners. For example, the principles of the invention can be practiced with a cutting insert having three, four, six, seven, eight, and the like, peripheral side surfaces and cutting corners. Each cutting corner 34, 36, 38, 40 and 42 defines resultant angles 43, 45 with respect to the plane 30 perpendicular to the top and bottom surfaces 12, 14, as shown in FIGS. 3 and 4. In general, the resultant angles 43, 45 can have different magnitudes from each other and can be larger than the true angle 28. For example, the resultant angles 43, 45 can be between about 3.50 degrees and about 4.00 degrees. As shown in FIG. 4, the resultant angles 45 are substantially identical to each other because of the symmetry of the cutting insert 10.

A plurality of cutting edges 44, 46, 48, 50, 52 are formed at the intersection between the top surface 12, the arcuate-shaped surface side surface 16a, 18a, 20a, 22a, 24a and the planar surface 16b, 18b, 20b, 22b, 24b of the adjacent side surface 16, 18, 20, 22, 24.

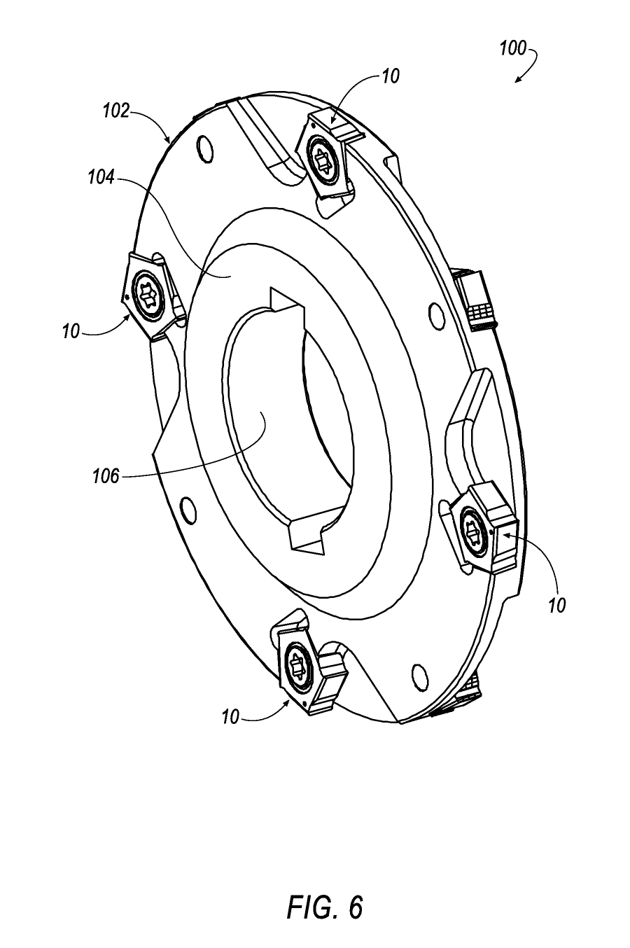

Referring now to FIGS. 6-9, a slotting cutter 100 is shown according to an embodiment of the invention. The slotting cutter 100 includes a disc-like cutter body 102 having a central hub region 104 that is provided with a bore 106 for receiving a support shaft (not shown). The slotting cutter 100 rotates on a central axis 105 perpendicular to a plane 107 of the cutter body 102 in a predetermined direction (indicated by the arrow 109). The central hub region 104 may also be provided with an optional keyway 111 for receiving a drive key (not shown).

The slotting cutter 100 is provided with a plurality of cutting insert receiving pockets 108 formed about the perimeter of the cutter body 102 that are capable of receiving the cutting insert 10. In the illustrated embodiment, the slotting cutter 100 includes five (5) pockets 108 equally spaced about the perimeter of the cutter body 102. However, it will be appreciated that most any suitable number of pockets 108 may be formed about the perimeter of the cutter body 102, depending on the desired material of the workpiece to be cut and the diameter of the cutter body 102. The cutter body 102 further includes one or more chip clearance surfaces 110 on its outer peripheral surface to prevent damage to the cutter body 102 by chips produced by the cutting insert 10.

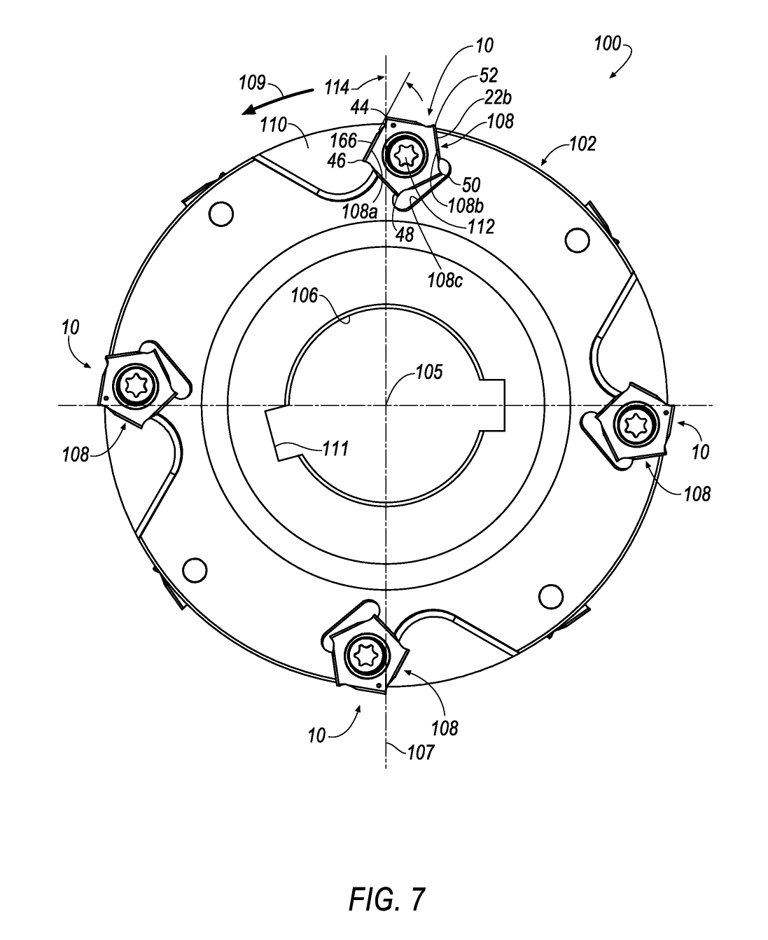

Each pocket 108 is defined by a forward surface 108a and a rearward surface 108b that are complementary in shape to planar surfaces 16b, 18b, 20b, 22b, 24b of the cutting insert 10. Each pocket 108 may also include a corner pocket relief 108c between the forward and rearward surfaces 108a 108b. When mounted in the pocket 108, two of the planar surfaces 16b, 18b, 20b, 22b, 24b of the cutting insert 10 contact the forward and rearward surfaces 108a, 108b of the pocket 108. For example, the planar surface 16b contacts the forward surface 108a and the planar surface 22b contacts the rearward surface 108b of the pocket 108, as shown in FIG. 7.

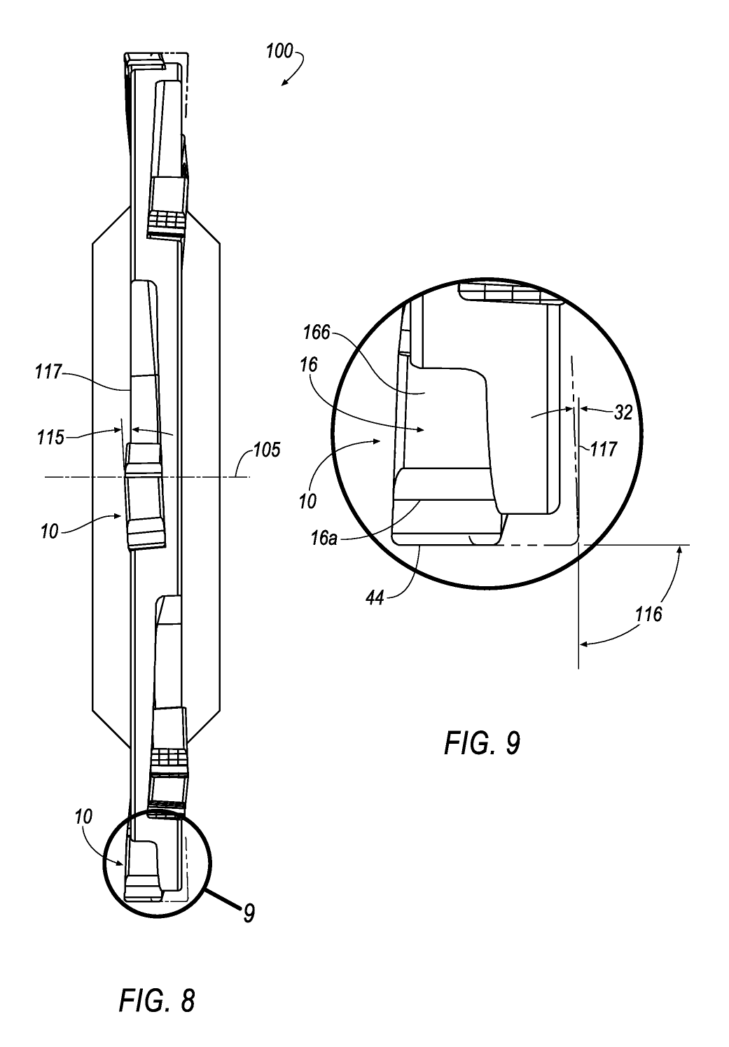

The cutting insert 10 is mounted in the pocket 108 with a mounting screw 112 with a radial rake angle 114 in a range between about twenty-five (25) degrees and about thirty (30) degrees with respect to the plane 107. For example, in the illustrated embodiment, the radial rake angle 114 is about twenty-eight (28) degrees, as shown in FIG. 7. In addition, the cutting insert 10 is mounted in the pocket 108 with an axial rake angle 115 in a range between about zero (0) degrees and about five (5) degrees with respect to a plane 117 perpendicular to the plane 107. For example, in the illustrated embodiment, the axial rake angle 115 is about three (3) degrees, as shown in FIG. 8.

As described above, the true angle 28 of the cutting insert 10 results in a relatively smaller resultant angle 32 when mounted in the slotting cutter 100 to produce a true ninety (90) degree wall on the workpiece (not shown) during a slotting cutting operation.

The documents, patents and patent applications referred to herein are hereby incorporated by reference.

While the invention has been specifically described in connection with certain specific embodiments thereof, it is to be understood that this is by way of illustration and not of limitation, and the scope of the appended claims should be construed as broadly as the prior art will permit.

1. A cutting insert for machining a workpiece, comprising:
a top surface;
a bottom surface;
a plurality of peripheral side surfaces extending between the top and bottom surfaces, each side surface including an arcuate-shaped surface and a substantially planar surface each arcuate-shaped surface being formed with a radius of curvature, R, and a depth, D; and
a plurality of cutting edges formed at an intersection between the top and bottom surfaces, the arcuate-shaped surface and the planar surface of an immediately adjacent peripheral side surface,
wherein each substantially planar surface is formed with a true angle with respect to a plane perpendicular to the top and bottom surfaces that results in a relatively smaller resultant angle when mounted in the slotting cutter to produce a true 90 degree wall on a workpiece during a slotting cutting operation.

2. The cutting insert according to claim 1, wherein the cutting insert is pentagon-shaped having five cutting corners formed at an intersection between each of the peripheral side surfaces and the top and bottom surfaces.

3. The cutting insert according to claim 1, wherein each planar surface contacts an inscribed circle, IC, of the cutting insert.

4. The cutting insert according to claim 1, wherein the top and bottom surfaces are parallel to each other.

5. The cutting insert according to claim 1, wherein the planar surface extends a greater distance along the peripheral side surface than the arcuate-shaped surface.

6. The cutting insert according to claim 1, wherein the axial rake angle is between 0 degrees and 5 degrees.

7. The cutting insert according to claim 6, wherein the axial rake angle is three 3 degrees.

8. A slotting cutter having a plurality of insert receiving pockets, each pocket having the cutting insert comprising:
a top surface;
a bottom surface;
a plurality of peripheral side surfaces extending between the top and bottom surfaces, each side surface including an arcuate-shaped surface and a substantially planar surface each arcuate-shaped surface, each being formed with a radius of curvature, R, and a depth, D; and
a plurality of cutting edges formed at an intersection between the top and bottom surfaces, the arcuate-shaped surface and the planar surface of an immediately adjacent peripheral side surface,
wherein each substantially planar surface is formed with a true angle with respect to a plane perpendicular to the top and bottom surfaces that results in a relatively smaller resultant angle when mounted in the slotting cutter to produce a true 90 degree wall on a workpiece during a slotting cutting operation.

9. The slotting cutter according to claim 8, wherein the slotting cutter further includes a disc-like cutter body having a central hub region wherein the slotting cutter rotates on a central axis perpendicular to a plane of the cutter body in a predetermined direction).

10. The slotting cutter according to claim 8, wherein the cutting insert is mounted on the pocket with a radial rake angle in a range between 25 degrees and 30 degrees with respect to the plane.

11. The slotting cutter according to claim 10, wherein the radial rake angle is 28 degrees

12. The slotting cutter according to claim 8, wherein the cutting insert is mounted on the pocket with an axial rake angle in a range between 0 degrees and 5 degrees with respect to a plane.

13. The slotting cutter according to claim 12, wherein the axial rake angle is 3 degrees
